(19) United States
(12) Patent Application Publication
(10) Pub. No.: US 2007/0217067 A1
(43) Pub. Date: Sep. 20, 2007

(54) Perpendicular Magnetic Recording Medium Using Soft Magnetic Layer Which Suppresses Noise Generation, And Perpendicular Magnetic Recording Apparatus Therewith

(75) Inventors: Futoshi Nakamura, Ichikawa-shi (JP); Tsutomu Tanaka, Ome-shi (JP); Yuka Aoyagi, Tachikawa-shi (JP); Kenji Shimizu, Ichihara-shi (JP); Hiroshi Sakai, Ichihara-shi (JP); Akira Sakawaki, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: KABUSHIKI KAISHA TOSHIBA and SHOWA DENKO K.K.

(21) Appl. No.: 10/593,966

(22) PCT Filed: Mar. 24, 2005
(86) PCT No.: PCT/JP05/06228

§ 371 Date: Sep. 22, 2006

Related U.S. Application Data
(60) Provisional application No. 60/558,556, filed on Apr. 2, 2004.

(30) Foreign Application Priority Data
Mar. 26, 2004 (JP) 2004-091014

(51) Int. Cl. G11B 5/31

(52) U.S. Cl. 360/126; 428/800; 977/960

(57) ABSTRACT

The magnetic recording medium of the present invention has a substrate, a perpendicular magnetic recording layer, and a soft magnetic layer formed therebetween, having a thickness of less than 100 nm, the soft magnetic layer having a magnetic anisotropy in a surface direction, and product Bs·Hc, which is a production of a saturation magnetic flux density Bs and a coercive force Hc, of not less than 79 T·A/m (10 kG·Oe). By making the thickness of the soft magnetic layer into the above-mentioned range, the magnetic anisotropy in surface direction can be stabilized. magnetostatic energy can be increased sufficiently by making the Bs·Hc the above-mentioned range. Therefore, generating of the magnetic wall in the soft magnetic layer can be suppressed, the noise generating from the soft magnetic layer can be suppressed, and a high-density recording is enabled.

Priority is claimed on Japanese Patent Application No. 2004-091014, filed Mar. 26, 2004, and U.S. Provisional Patent Application No. 60/558,556 filed Apr. 2, 2004, the contents of which are incorporated herein by reference.

### TECHNICAL FIELD

The present invention relates to a magnetic recording medium which may be used in a hard disk drive or the like, to a manufacturing method therefor, and to a magnetic record reproducer.

### BACKGROUND ART

Because a perpendicular magnetic recording system can reduce the magnetization transition region which is the boundary of a recorded bit by turning the magnetization easy axis of a magnetic recording layer in the perpendicular direction to a substrate, the perpendicular magnetic recording system is one which is suitable for improving recording density.

As a magnetic recording medium using the perpendicular magnetic recording system, one that is called a perpendicular two-layer medium, in which a soft magnetic layer is formed between the substrate and the perpendicular magnetic recording layer, has been widely used. The perpendicular two-layer medium can acquire high recording capability by using a single magnetic pole head as a magnetic head.

This is because the soft magnetic layer serves to return the recording magnetic field from the magnetic head in the perpendicular two-layer medium, which can improve the reading-writing efficiency.

However, there is a problem in the perpendicular two-layer medium in that the noise resulting from the soft magnetic layer of the perpendicular two-layer medium, particularly the noise resulting from a magnetic wall, is large.

In order to suppress the magnetic wall formation of the soft magnetic layer so as to control the noise of the medium, heretofore, various proposals have been made.

Japanese Unexamined Patent Application, First Publication No. 2003-151 (Patent document 1) discloses a magnetic recording medium which is a perpendicular two-layer medium which is produced by a method of applying direct-current bias voltage to a substrate upon forming a soft magnetic layer by a sputtering method.

In this magnetic recording medium, the direct-current bias voltage is applied to the substrate upon forming the soft magnetic layer to avoid generation of a microscopic magnetic anisotropy leading to noise in the soft magnetic layer.

In this magnetic recording medium, the coercive force of the soft magnetic layer is preferably not higher than 10 (Oe). As for the thickness of the soft magnetic layer, it is exemplified that the thickness may be not less than 50 nm, preferably not less than 80 nm, and more preferably not less than 100 nm. As for the saturation magnetic flux density Bs, it is exemplified that the saturation magnetic flux density may be not less than 0.7 T, preferably not less than 1. T, and more preferably not less than 1.2 T.

However, in this magnetic recording medium, the magnetic wall which divides the entire soft magnetic layer into a plurality of regions is easily generated, and hence it was difficult to suppress the noise which is generated from the soft magnetic layer.

Japanese Unexamined Patent Application, First Publication No. 2003-150544 (Patent document 2) discloses a magnetic recording medium which is constituted such that the thickness distribution of a soft magnetic layer or the size of saturation magnetization changes as a function of the distance from the center of a substrate.

In this magnetic recording medium, the magnetostatic energy of the soft magnetic layer is reduced, such that the soft magnetic layer has a single magnetic region structure, thereby avoiding generation of the noise by the magnetic wall, and the deterioration of an error rate, or the like.

However, in this magnetic recording medium, the magnetic flux emitted from the soft magnetic layer differs in radial directions, and there is a problem in that that characteristic becomes uneven.

Moreover, the stability of the single magnetic region structure deteriorates, such that generation of noise could not be suppressed sufficiently.

Japanese Unexamined Patent Application, First Publication No. H06-76202 (Patent document 3) discloses a magnetic reading-writing apparatus which is equipped with a magnetic recording medium which has a soft magnetism lining layer and a perpendicular magnetic recording layer, and a magnetic head. The magnetic head is equipped with a magnetic field generating element which can apply a magnetic field to the soft magnetism lining layer.

In this magnetic reading-writing apparatus, the magnetic recording medium which has the soft magnetism lining layer formed by the RF weld slag method is used. As the soft magnetism lining layer, one which has a thickness of 100 μm, and the coercive force of the direction of the inside of a field being 10 (Oe), and which consists of CoZrNb is exemplified.

It is thought that the saturation magnetic flux density of the soft magnetism lining layer is approximately 1.3 T.

Because the thickness of the soft magnetism lining layer is 100 μm, if the magnetic anisotropy faces inside a plane, the coercive force directed inside the plane should become very low (it is thought that it becomes approximately 1 (Oe) or less).

Because the coercive force directed inside the plane of the soft magnetism lining layer is set to be 10 (Oe), it is thought that the magnetic anisotropy of the soft magnetism lining layer does not face inside the plane.

As the situation stands, it is difficult to sufficiently suppress the noise which is generated from the soft magnetic layer in such a magnetic recording medium.

Patent document 1: Japanese Unexamined Patent Application, First Publication No. 2003-151

Patent document 2: Japanese Unexamined Patent Application, First Publication No. 2002-150544

Patent document 3: Japanese Unexamined Patent Application, First Publication No. H06-76202

### DISCLOSURE OF INVENTION

The present invention was made in view of the above-mentioned circumstances, and objects of the present invention is to provide a magnetic recording medium which enables high-density recording by suppressing the noise generated from the soft magnetic layer, to provide a manufacturing process, and to provide a magnetic reading-writing apparatus.

In order to attain the above-mentioned objects, the present invention adopts the following constitutions:

(1) The first aspect of the present invention is a magnetic recording medium including a substrate, a perpendicular magnetic recording layer, and a soft magnetic layer formed therebetween, wherein the soft magnetic layer has a thickness of less than 100 nm, a magnetic anisotropy in a surface direction, and a Bs·Hc, which is a product of a saturation magnetic flux density Bs and a coercive force Hc, of not less than 79 T.A/m (10 kG·Oe).

(2) The second aspect of the present invention is a magnetic recording medium including a substrate, a perpendicular magnetic recording layer, and a plurality of soft magnetic layers formed therebetween, wherein the plurality of soft magnetic layers have a total thickness of less than 100 nm, a magnetic anisotropy in a surface direction, and a Bs·Hc, which is a product of a saturation magnetic flux density Bs and a coercive force Hc, of not less than 79 T·A/m (10 kG·Oe).

(3) In the magnetic recording medium in the above, the magnetic anisotropy of the soft magnetic layer is preferably in a surface direction of the substrate.

(4) In the magnetic recording medium in the above, a hard magnetic layer, which suppresses a magnetic wall formation in the soft magnetic layer, is preferably disposed between the substrate and the soft magnetic layer.

(5) In the magnetic recording medium in the above, the hard magnetic layer is constituted so as to be magnetized in a direction substantially parallel to the direction of the magnetic anisotropy of the soft magnetic layer.

(6) The third aspect of the present invention is a process for producing a magnetic recording medium having a substrate, a perpendicular magnetic recording layer, and a soft magnetic layer formed therebetween, wherein the soft magnetic layer is formed, such that the thickness of the soft magnetic layer should be less than 100 nm, the magnetic anisotropy thereof should to be in a surface direction, and a Bs·Hc, which is a product of a saturation magnetic flux density Bs and a coercive force Hc, should be not less than 79 T·A/m (10 kG·Oe).

(7) In the magnetic reading-writing apparatus including the magnetic recording medium in the above, and a magnetic head for recording and reproducing information to the magnetic recording medium, wherein the magnetic head is a single magnetic pole head.

It should be noted that 1 (Oe) is approximately 79 A/m, and that 1 G is 10⁻⁴ T.

In addition, the thickness of each layer can be obtained by observing a cross section of the medium, for example by a TEM (transmission electron microscope).

The magnetic recording medium of the present invention has a soft magnetic layer which has a thickness of less than 100 nm, a magnetic anisotropy in a surface direction, and a Bs·Hc which is a product of the saturation magnetic flux density Bs and a coercive force Hc, of not less than 79 T·A/m (10 kG·Oe).

By making the thickness of the soft magnetic layer to be in the above-mentioned range, the magnetic anisotropy of the direction in surface direction can be stabilized. Moreover, magnetostatic energy can be increased sufficiently by making the Bs·Hc to be in the above-mentioned range.

In the magnetic recording medium of the present invention, because the magnetic anisotropy in a surface direction is given to the soft magnetic layer and the magnetostatic energy is increased, the magnetic wall formation in the soft magnetic layer can be suppressed.

Therefore, the noise generating from the soft magnetic layer can be suppressed, and high-density recording can be performed.

### BRIEF DESCRIPTION OF THE DRAWINGS

FIG. 1 is a sectional view showing a first example of the magnetic recording medium of the present invention.

FIG. 2 is a sectional view showing a second example of the magnetic recording medium of the present invention.

FIG. 3 is a sectional view showing a third example of the magnetic recording medium of the present invention.

FIG. 4 is a diagram explaining the advantageous effect obtainable from the present invention.

FIG. 5 is a schematic view showing an example of the magnetic reading-writing apparatus of the present invention.

FIG. 6 is a schematic view showing a magnetizing device used in a Working Example of the present invention.

FIG. 7 is graph showing a test result.

FIG. 8 is graph showing a test result.

FIG. 9 is a sectional view showing a fourth example of the magnetic recording medium of the present invention.

### EXPLANATION OF SYMBOLS

1 . . . Substrate,
2 . . . Hard magnetic layer,
3, 3a, 3b . . . Soft magnetic layer,
4 . . . Seed layer,
5 . . . Base layer,
6 . . . Perpendicular magnetic recording layer,
7 . . . Protective layer

### BEST MODE FOR CARRYING OUT THE INVENTION

The magnetic recording medium of the present invention is a perpendicular magnetic recording medium which has a substrate, a perpendicular magnetic recording layer, and a soft magnetic layer formed therebetween.

As the substrate, a metal substrate which consists of a metal material, such as aluminum or an aluminum alloy, may be used, and a nonmetallic substrate which consists of nonmetallic materials, such as glass, ceramics, silicon, silicon carbide, and carbon, may be used.

Amorphous glass and crystallized glass can be used as the glass. As the amorphous glass, general-purpose soda lime glass and aluminosilicate glass can be used. Lithium-type crystallized glass can be used as a crystallized glass. As a ceramic substrate, a sintered compact which contains an aluminum oxide, aluminum nitride, silicon nitride, and the like, as a main ingredient, and fiber reinforced composites thereof can be used.

The soft magnetic layer is one which consists of a soft magnetic material, and as the soft magnetic material, one which contains at least one selected from the group consisting of Fe and Co, as a main ingredient, is preferred.

As a material for the soft magnetic layer, a FeCo alloy (FeCo, FeCoB, FeCoBC, or the like), a FeNi alloy (FeNi, FeNiMo, FeNiCr, FeNiSi, or the like), a FeAl alloy (FeAl, FeAlSi, FeAlSiCr, FeAlSiTiRu, FeAlO, or the like), a FeCr alloy(FeCr, FeCrTi, FeCrCu, or the like), a FeTa alloy (FeTa, FeTaC, FeTaN, or the like), a FeMg alloy (FeMgO or the like), a FeZr alloy (FeZrN or the like), a FeC alloy, a FeN alloy, a FeSi alloy, a FeP alloy, a FeNb alloy, a FeHf alloy, a FeB alloy, a CoB alloy, a CoP alloy, a CoNi alloy (CoNi, CoNiB, CoNiP, or the like), a CoZr alloy (CoZrNb, CoZrTa, CoZrCr, CoZrMo, or the like), a CoNb alloy, a CoTa alloy, a CoCr alloy, a CoMo alloy, a FeCoNi alloy (FeCoNi, FeCoNiP, FeCoNiB, or the like) can be exemplified.

Particularly, it is preferred to use FeCoBC which is the material containing boron carbide (B₄C), for the soft magnetic layer 3.

The soft magnetic layer may contain at least one selected from the group consisting of O, C, and N. Thereby, at least one of an oxide, carbide, and nitride generated at the grain boundary, and which refines a magnetic grain. As a result, a magnetic wall becomes difficult to generate.

The soft magnetic layer has magnetic anisotropy in a surface direction.

The direction of the magnetic anisotropy of the soft magnetic layer is preferably a radial direction of the substrate in the above.

By making the direction of the magnetic anisotropy to be a radial direction, it becomes easy to suppress forming of a magnetic wall.

The phrase “having magnetic anisotropy in a surface direction” means that the saturation magnetic field in a surface direction is smaller than the saturation magnetic field in a perpendicular direction. The saturation magnetic field is the minimum of the external magnetic field which is necessary for the magnetic flux density of the soft magnetic layer to reach a saturation state.

The thickness of the soft magnetic layer is less than 100 nm (preferably not higher than 80 nm).

By making the thickness of the soft magnetic layer in this range, the magnetic anisotropy in a surface direction can be stabilized. Moreover, productivity can be increased.

In order to obtain sufficient soft magnetic characteristics, the thickness of the soft magnetic layer is preferably not less than 10 nm.

The saturation magnetic flux density Bs of the soft magnetic layer is preferably not less than 7000 G (0.7 T).

The coercive force Hc of the soft magnetic layer is preferably not less than 1 (Oe) and not higher than 100 (Oe). Because it is difficult to set Bs to be a high value, it becomes difficult to make the Bs·Hc value to be not less than 79 T·A/m (10 kG·Oe), if the coercive force Hc is less than 1 (Oe).

If the coercive force Hc is higher than 100 (Oe), the soft magnetic characteristics of the soft magnetic layer becomes insufficient.

As for the soft magnetic layer, the product Bs·Hc of the saturation magnetic flux density Bs and the coercive force Hc is not less than 79 T·A/m (10 kG·Oe) (preferably not less than 395 T·A/m (50 kG·Oe)).

A noise can be suppressed by making the Bs·Hc into this range.

The magnetostatic energy becomes large, if the Bs·Hc is large, because the magnetostatic energy U of the soft magnetic layer is expressed as the following formurae:
U=(½)∫∫∫B·Hdv

B: magnetic flux density, H: magnetic field

As for the soft magnetic layer, a plurality of soft magnetic layers may be formed.

In the case in which a plurality of soft magnetic layers is formed, these soft magnetic layers may be laminated continuously, and may be laminated through other layers.

In this case, the characteristics (thickness, Bs·Hc, and the like) of each soft magnetic layer are set, so that it may be within the above range, when the soft magnetic layer of these plural layers is considered to be one soft magnetic layer.

That is, thickness of the plurality of soft magnetic layers is set to be less than (preferably not higher than 80 nm) 100 nm in total. Thereby, the magnetic anisotropy in a surface direction can be stabilized. Moreover, the thickness of the soft magnetic layer is preferably not less than 10 nm in total.

In addition, the plurality of the soft magnetic layers, which are regarded as a single soft magnetic layer, have the magnetic anisotropy in a surface direction.

Furthermore, the plurality of soft magnetic layers in the above are constituted such that the product Bs·Hc of the saturation magnetic flux density Bs and the coercive force Hc should be not less than 79 T·A/m (10 kG·Oe) (preferably not less than 395 T·A/m (50 kG·Oe)), when the plurality of soft magnetic layers are regarded as a single soft magnetic layer. Noise can be suppressed by making the product Bs·Hc into this range.

Between the substrate and the soft magnetic layer, a hard magnetic layer which suppresses magnetic wall formation in the soft magnetic layer may be disposed.

The hard magnetic layer is made of a hard magnetic material, and the hard magnetic layer preferably has a magnetic anisotropy in a surface direction.

The hard magnetic layer can heighten the effect of suppressing magnetic wall formation in the soft magnetic layer, if the magnetization direction is made almost parallel to the direction of the magnetic anisotropy of the soft magnetic layer.

As a material of the hard magnetic layer, a CoCrPt alloy, a CoCrPtB alloy, a CoCrPtTa alloy, a CoSm alloy, a CoPt alloy, a CoPtO alloy, a CoPtCrO alloy, CoPt—SiO₂ alloy, a CoCrPt—SiO₂ alloy, and a CoCrPtO—SiO₂ alloy can be exemplified.

The hard magnetic layer may have a two-layer structure. For example, the hard magnetic layer has a structure consisting of the first layer which is made of V, and the second layer which is a magnetic layer made of a Co alloy such as CoPtCr formed on the first layer.

The hard magnetic layer preferably has a coercive force Hc of not less than 2000 (Oe) (preferably not less than 3000 (Oe)).

By the hard magnetic layer, the magnetic wall formation in the soft magnetic layer can be suppressed, and generating of spike noise can be prevented.

A seed layer may be formed on the soft magnetic layer.

For the seed layer, an alloy containing at least one selected from the group consisting of Fe, Co, Ni, Cr, V, Mo, Nb, Zr, W, Ta, B, and C.

As this material, a NiTa alloy, a NiNb alloy, a NiTaC alloy, a NiTaB alloy, a CoNiTa alloy, a NiFe alloy, a NiFeMo alloy, a NiFeCr alloy, a NiFeV alloy, and a NiCo alloy are preferred.

The seed layer preferably has a micro-crystallite structure having a detailed crystal grain, or a face-centered cubic structure.

Soft magnetic material may be used for the seed layer. For example, the saturation magnetic flux density Bs may be not less than 0.2 T, while the coercive force Hc may be not higher than 100 (Oe).

In the case in which the soft magnetic material is used for the seed layer, the seed layer serves as a soft magnetic layer.

In this case, the above-mentioned soft magnetic layer and the above-mentioned seed layer can be regarded as a single soft magnetic layer having a two-layer structure. In this case, the characteristics (thickness, magnetic anisotropy, and Bs·Hc) of the soft magnetic layer of the two-layer structure are preferably in the above-mentioned range, respectively.

A base layer containing Ru can be disposed between the seed layer and the perpendicular magnetic recording layer. Ru or a Ru alloy can be exemplified as this material. As the Ru alloy, a RuCr alloy, a RuCo alloy, and a RuPt alloy can be exemplified.

By disposing the base layer, in the perpendicular magnetic recording layer, orientation increases, thereby increasing resolution and SNR.

The perpendicular magnetic recording layer is one in which a magnetization easy axis is mainly directed perpendicularly to the substrate. Co alloy can be used for the perpendicular magnetic recording layer. In particular, a Co alloy which contains a metal oxide or a semiconductor oxide is preferred. The perpendicular magnetic recording layer may have a particle distributed structure (granular structure).

As the Co alloy, a CoCr alloy, a CoPt alloy, a CoCrPt alloy, a CoCrPtTa alloy, a CoCrPtO alloy, and a CoCrPtTaB alloy can be exemplified.

As the metal which constitutes the above-mentioned metal oxide, Cr, Al, Ta, Zr, Mg, Ti, and Y can be exemplified, and Si and B can be exemplified as the semiconductor which constitutes a semiconductor oxide.

As a metal oxide, at least one selected from the group consisting of Y₂O₃, Cr₂O₃, Al₂O₃, Ta₂O₅, TiO, Ti₂O₃, and TiO₂ can be exemplified. As a semiconductor oxide, SiO₂ and B₂O₃ can be exemplified.

When the perpendicular magnetic recording layer has the granular structure, the perpendicular magnetic recording layer may have a constitution in which the magnetic particle consisting of the above-mentioned Co alloy is distributed to a mother material which consists of the above-mentioned metal oxide, a semiconductor oxide, or the like.

Because the base layer will be excellent in uniformity in particles, clearness in particles, smallness of particle diameter, and orientation in particles, in the case in which the above-mentioned base layer is disposed, the perpendicular magnetic recording layer which grows epitaxially under the influence of the base layer will be excellent in uniformity in particles (magnetic particle), clearness in particles, smallness of particle diameter, and orientation in particles.

In particular, the perpendicular magnetic recording layer which consists of a Co alloy containing a metal oxide or a semiconductor oxide will be excellent in uniformity in particles, clearness in particles, smallness of particle diameter, and orientation in particles. For this reason, superior resolution and superior noise characteristic are obtained.

When using a Co alloy which contains a metal oxide or a semiconductor oxide in the perpendicular magnetic recording layer, the perpendicular magnetic recording layer is preferably formed under the conditions (for example, at a substrate temperature of less than 100° C.) of not heating. If this temperature is too high, particle diameter will increase so as to make it insufficient to separate the particles from the mother material.

When using a Co alloy which is free from a metal oxide or a semiconductor oxide in the perpendicular magnetic recording layer, the perpendicular magnetic recording layer is preferably to be formed under heating conditions (for example, at a substrate temperature of not lower than 100° C.). If this temperature is too low, in the perpendicular magnetic recording layer, segregation is likely to be insufficient.

When using a Co alloy which is free from a metal oxide or a semiconductor oxide in the perpendicular magnetic recording layer, an weak magnetism base layer which consists of Co alloys (a CoCr alloy, a CoPt alloy, a CoCrPt alloy, a CoCrPtTa alloy, a CoCrPtO alloy, a CoCrPtTaB alloy, or the like) of which Co concentration is lower than that of the Co alloy may be disposed directly under the perpendicular magnetic recording layer. It should be noted that the weak magnetism base layer may be nonmagnetic.

Onto the perpendicular magnetic recording layer, a protective layer which consists of C, SiO₂, ZrO₂, or the like, may be disposed.

Onto the protective layer, a lubricating layer which consists of perfluoropolyether, fluorinated alcohol, fluorinated carboxylic acid, or the like may be disposed.

The above-mentioned each layer may be disposed at one side of the substrate, and may be disposed at both sides. The above-mentioned each layer may be disposed by a sputtering method.

The present invention will be explained more in detail below, by giving examples.

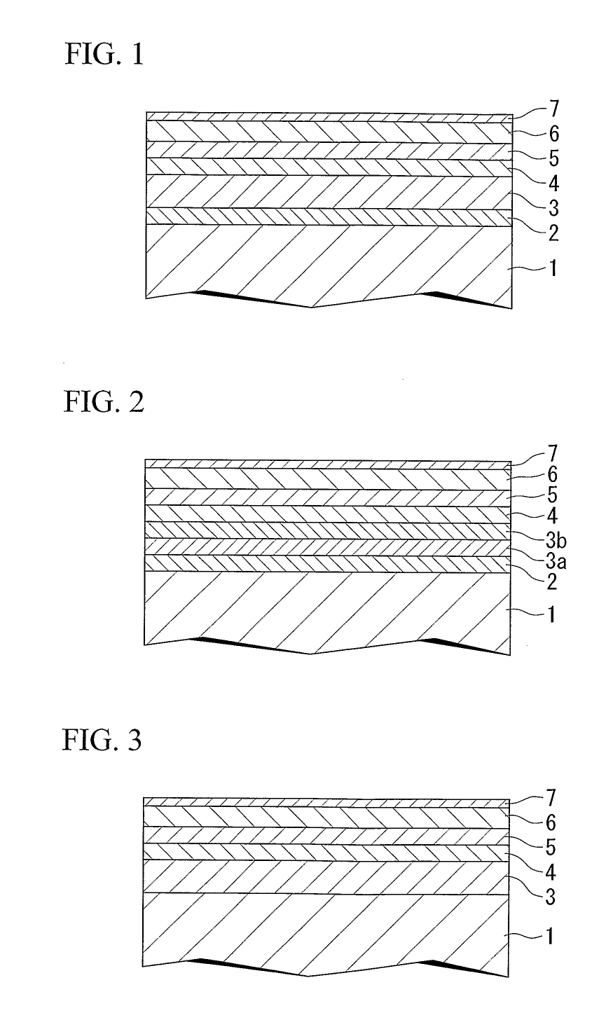

The magnetic recording medium shown in FIG. 1 has the constitution consisting of the hard magnetic layer 2, the soft magnetic layer 3, the seed layer 4, the base layer 5, the perpendicular magnetic recording layer 6, and the protective layer 7 which are laminated in this order on the substrate 1.

The magnetic recording medium shown in FIG. 2 differs from the magnetic recording medium shown in FIG. 1 in that two soft magnetic layers 3a and 3b are disposed instead of the soft magnetic layer 3.

The magnetic recording medium shown in FIG. 3 differs from the magnetic recording medium shown in FIG. 1 in that the hard magnetic layer 2 is not disposed.

The advantageous effects obtainable from the present invention will be explained below.

In general, the soft magnetic layer of the perpendicular magnetic recording medium forms a part of a magnetic path of the magnetic flux generated from the magnetic head in writing, whereas in reading, the same soft magnetic layer serves as a promoter for promoting the magnetic flux leakage from the magnetic recording layer.

Heretofore, it is thought that the soft magnetic layer is preferably thick and the coercive force is preferably small, in order to fully exert the effect of magnetic flux.

Moreover, it is thought that it is more desirable to suppress the magnetic anisotropy, in order to prevent the fine magnetic region which causes a noise in the soft magnetic layer from being formed.

In addition, because the magnetic wall formation will advance by a formation of a flowing-back magnetic region when the magnetostatic energy of the soft magnetic layer is large, heretofore, it is generally thought that it is desirable to suppress the magnetostatic energy in order to reduce noise.

However, the inventor of the present invention researched thoroughly and discovered that in the magnetic recording medium having the characteristics which have been thought to be desirable, it becomes easy to generate magnetic walls which roughly divides the soft magnetic layer entirely into a plurality of regions.

In the magnetic recording medium of the present invention, thickness is less than 100 μm, the soft magnetic layer has the magnetic anisotropy in a surface direction, and the product Bs·Hc of the saturation magnetic flux density Bs and the coercive force Hc is not less than 79 T·A/m (10 kG·Oe).

By making the thickness of the soft magnetic layer into the above-mentioned range, the magnetic anisotropy in a surface direction can be stabilized. Moreover, the magnetostatic energy can be increased sufficiently by making the product Bs·Hc into the above-mentioned range.

In the magnetic recording medium of the present invention, because the magnetic anisotropy in a surface direction is applied to the soft magnetic layer and the magnetostatic energy is increased, the magnetic wall formation in the soft magnetic layer can be suppressed.

Therefore, the noise resulting from the soft magnetic layer can be suppressed, and a high-density recording is provided.

With respect to the reason the formation of the magnetic wall is suppressed when the soft magnetic layer has the magnetic anisotropy in a surface direction and the magnetostatic energy is large, the following is hypothesized.

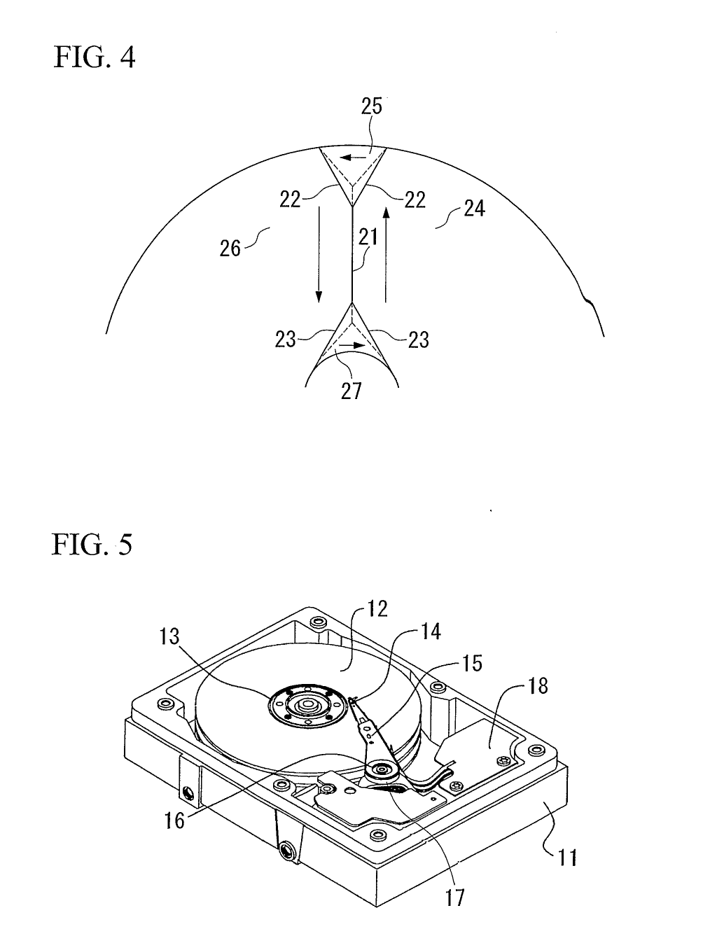

As shown in FIG. 4, a soft magnetic layer in which the magnetic regions 24-27 which are flow-back magnetic domains are formed is supposed. The magnetic regions 24-27 consist of the magnetic wall 21 elongated radially, two magnetic walls 22 and 22 elongated towards a perimeter edge from the end of the magnetic wall 21, and two magnetic walls 23 and 23 elongated towards an inner circumference edge from the other end of the magnetic wall 21.

It becomes easy to expand the magnetic domains 24 and 26 of which magnetization directions shown by an arrow are identical with the direction of the magnetic anisotropy radially, by giving the magnetic anisotropy in a surface direction (radial direction in the example shown in the drawing) to the soft magnetic layer.

Therefore, as shown by a dashed line, it becomes easy for the magnetic walls 22 and 23 to be formed in a position near to a perimeter edge and an inner circumference edge, respectively, such that the magnetic domains 25 and 27 become small. For this reason, the magnetostatic energy will increase.

If the magnetic anisotropy given to the soft magnetic layer is large sufficiently, the magnetic domains 25 and 27 by the side of the perimeter and inner circumference will not be formed. That is, the magnetic walls 22 and 23 will not be formed.

Thus, because formation of the magnetic walls 22 and 23 can be suppressed, noise generation caused by the magnetic walls 22 and 23 can be reduced.

In this example, because the magnetic anisotropy of the soft magnetic layer is directed radially, even when the magnetic anisotropy is relatively small, the magnetic walls 22 and 23 are hardly formed.

FIG. 5 is a perspective view showing an example of the magnetic reading-writing apparatus (perpendicular magnetic recording apparatus) of the present invention.

The magnetic reading-writing apparatus shown here has a case 11 having a shape of a rectangular box of which the upper surface side is equipped with an opening, and a top cover which closes the opening of the case 11.

In the case 11, the magnetic recording medium 12 which has the above-mentioned constitution, the spindle motor 13 as the driving device to support and rotate the magnetic recording medium 12, the magnetic head 14 (single magnetic pole head) to conduct recording and reproducing of a magnetic signal to the magnetic recording medium 12, the head actuator 15 which has a suspension of which a tip end is equipped with the magnetic head 14 and supports the magnetic head 14 movably, the rotation axis 16 which supports the head actuator 15 rotatably, the voice coil motor 17 which rotates and positions the head actuator 15 through the rotation axis 16, and the head amplifier circuit 18 are stored.

### WORKING EXAMPLES

### Working Example 1

The magnetic recording medium shown in FIG. 1 was produced as shown below.

In the production process mentioned below, Ar gas was used as sputtering gas in a sputtering method using a chamber in which the degree of vacuum was set to be not higher than 3×10⁻⁵ Pa.

A hard magnetic layer 2 which has the magnetic anisotropy in a surface direction is formed on the substrate 1 which is made of a glass by a sputtering method. The hard magnetic layer 2 was formed so as to have the constitution including the first layer (40 nm in thickness) which consists of V and the second layer (20 nm in thickness) which consists of Co:18 at %, Pt: 8 at %, and Cr, formed on the first layer.

When forming the first layer, the pressure in the chamber was set to be 0.6 Pa using the target which consists of V. When forming the second layer, the pressure in the chamber was set to be 0.5 Pa using the target which consists of the above CoPtCr.

Subsequently, the soft magnetic layer 3 (80 nm in thickness) which consists of Fe: 27 at %, Co: 8 at %, B: 2 at %, and C was formed on the hard magnetic layer 2.

When forming the soft magnetic layer 3, the electric discharging was performed while disposing a rare earth permanent magnet to the back of the target which consists of the above FeCoBC (Fe: 27 at %, Co: 8 at %, B: 2 at % and C), so that the magnetic flux might leak radially from the center towards the perimeter of the target (pressure in the chamber: 0.6 Pa).

Subsequently, onto the soft magnetic layer 3, the seed layer 4 (7 nm in thickness) which consists of NiTa was formed (the pressure in the chamber: 0.7 Pa), using a nickel 30 at % Ta target.

When forming the above-mentioned each layer, electric power supplied to the target was set to be DC 500W.

Subsequently, the base layer 5 (5 nm in thickness) which consists of Ru was formed on the seed layer 4, using the target which consists of Ru. When forming the base layer 5, the pressure in the chamber was set to be 3.0 Pa, and the power supplied to the target was set to be DC 250W.

Subsequently, the perpendicular magnetic recording layer 6 (10 nm in thickness) which consists of CoPtCr—SiO₂ was formed on the base layer 5. When forming the perpendicular magnetic recording layer 6, a CoPtCr—SiO₂ target was used. The CoPtCr—SiO₂ target was produced by mixing a Co: 16 at %, Pt: 12 at %, and Cr particle with SiO₂ particles uniformly, so that it might become a molar ratio CoPtCr:SiO₂=11:1 and was sintered. The pressure in the chamber was set to be 6.0 Pa, and the power supplied to the target was set to be RF 200W.

Subsequently, the protective layer 7 (7 nm in thickness) which consists of C was formed on the perpendicular magnetic recording layer 6 using the target which consists of C. When forming the protective layer 7, the pressure in the chamber was set to be 0.5 Pa, and the power supplied to the target was set to be DC 1000W.

Subsequently, to the protective layer 7, using a sputtering method, a lubricant which consists of PFPE (perfluoropolyether) was applied, so that the thickness might be set to be 1.5 nm, and the magnetic recording medium A having the constitution shown in FIG. 1 was obtained.

The medium A has the constitution including the substrate 1, the hard magnetic layer 2, the soft magnetic layer 3 which consists of FeCoBC, the seed layer 4 which consists of NiTa, the base layer 5 which consists of Ru, the magnetic recording layer 6 which consists of CoPtCr—SiO₂, the protective layer 7 which consists of C, and the lubricating layer (which is not shown in the drawing), each layer of which is laminated in this order.

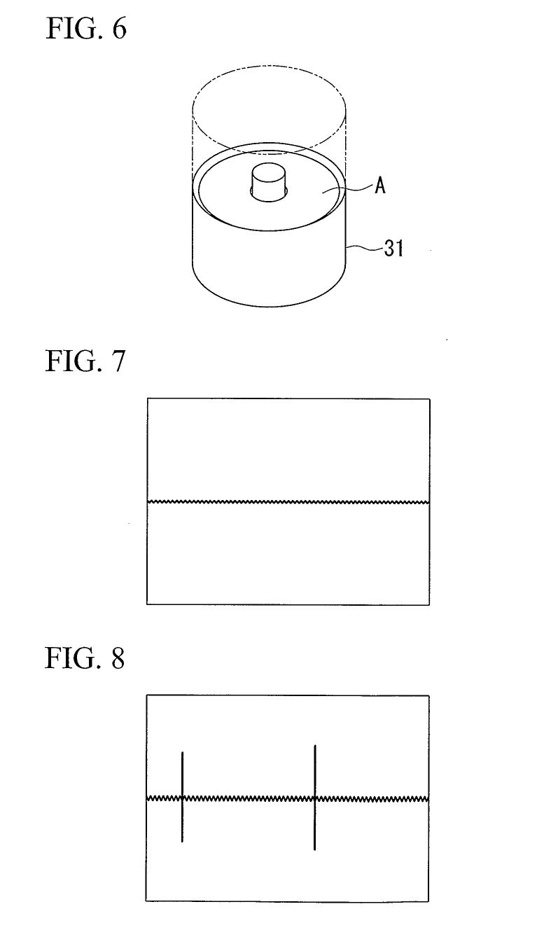

The radial pulsed magnetic field (10000 (Oe)) was applied to the medium A from both sides to magnetize the medium A, using the magnetizing apparatus 31 shown in FIG. 6.

In order to evaluate the characteristics of the medium A, the samples 1 to 3 shown below were prepared. Constitutions of the substrate 1 and each layer which are used for samples 1 to 3 were made to be the same as that of the medium A.

On the substrate 1, the hard magnetic layer 2, the soft magnetic layer 3, the seed layer 4, the base layer 5, and the perpendicular magnetic recording layer 6 were formed one by one to obtain the sample 1.

Only the soft magnetic layer 3 was formed on the substrate 1 to obtain the sample 2.

The sample was prepared by forming the hard magnetic layer 2, the soft magnetic layer 3, the seed layer 4, the base layer 5, and the perpendicular magnetic recording layer 6 one by one on the substrate 1. The sample thus prepared was magnetized, using the magnetizing apparatus 31 to obtain the sample 3.

Test pieces in the form or squares 1 cm at each side were cut out from the samples 1 to 3. Each of these test pierces has a shape such that two sides facing to each other are approximately along the radial direction of each of the samples 1 to 3, respectively.

The test pieces of the samples 1 to 3 were, as described below, subjected to the magnetostatic characteristic evaluation using VSM (Vibrating Sample Magnetometer). The results are shown in Table 1.

When an external magnetic field having a maximum of 15 kOe was applied and the square-shaped ratio RS and the coercive force Hc were measured as to the sample 1, the square-shaped ratio RS which is the value obtained by dividing the residual magnetization with the saturation magnetization approximately both the radial direction and the direction of the circumference was 0.96, and the coercive force Hc was 2800 (Oe).

When an external magnetic field having a maximum of 100 (Oe) was applied and the saturation magnetic flux densities Bs, Hc, and RS were measured as to the sample 2, the Bs was 16000G, the Hc in a radial direction was 0.7 (Oe), and the Hc in the direction of the circumference was 50 (Oe) and the RS was 1.0.

Moreover, when the hysteresis loop (BH curve) was created as to the direction of the circumference, the saturation magnetic flux density could not be decided even if the external magnetic field was increased, hence it was judged that the magnetization easy axis is directed to the radial direction (that is, the magnetic anisotropy is directed radially).

The product Bs·Hc of the sample 2 was 11.2kG·Oe (88.5 T·A/m).

Moreover, when the hysteresis loop was created as to the radial direction of the sample 3, the central point of this loop was located in the position which is shifted by approximately 50 (Oe) in the right direction of H from the central point of the loop created as to the radial direction of the sample 2.

It was checked that the gap width of the loop central point of the samples 2 and 3 becomes largest when it is measured in a radial direction.

From this result, each of the magnetization directions of the hard magnetic layer 2 and directions of the magnetic anisotropy of the soft magnetic layer 3 was judged to be a radial direction.

As to the magnetic recording medium A, using the Kerr effect magnetism measurement apparatus, the external magnetic field having a maximum of 20 kOe was applied, and magnetostatic characteristics were evaluated. The coercive force Hc, and the square-shaped ratio Rs and the nuclear generation magnetic field (-Hn) are shown in Table 1.

Moreover, the R/W characteristic (which is referred to as R/W measurement, hereinafter) was evaluated by the method of writing in the medium A using a single magnetic pole head and of reading a signal using an MR head.

In the R/W measurement, SNRm, the over-writing characteristic (OW), and half breadth (dPW50) were measured. The result is shown in Table 1.

The point of measurement was set to be the position equivalent to the radius of 20 mm, and revolving speed of the medium was set to be 4200 rpm.

In the SNRm, S denotes a peak value in the 1 flux reversal of the isolated wave form of 716 kFCI, that is, ½ of the difference between the maximum value and the minimum value. Nm denotes a rms value (root mean square-inches) at 60 kFCI.

An overwriting characteristic indicates a ratio of the output signal before overwriting and the residual output signal after overwriting after the recording signal in 358kFCI is written, and when the signal of 48 kFCI is overwritten.

The dPW50 is one which denotes the resolution characteristic, that is, the width (nm) in 50% of the peak value of the isolated wave form obtained by differentiating the read waveform.

### Comparative Examples 1 to 3

Magnetic recording media B, C, and D in which the soft magnetic layer 3 which consists of Co: 6 at %, Zr: 10 at %, and Nb is substituted for the soft magnetic layer 3 which consists of FeCoBC of the medium A (in Working Example 1). The thickness of the soft magnetic layer 3 of the media B, C, and D was set to be 80 nm, 160 nm, and 240 nm, respectively.

In forming the soft magnetic layer 3, the electric discharging was performed while disposing a rare earth permanent magnet at the back of the target which consists of the above CoZrNb (Co: 6 at %, Zr: 10 at %, and Nb), so that the magnetic flux might leak radially from the center towards the perimeter of the target. The other conditions were the same as in the Working Example 1.

In order to evaluate the characteristics of the soft magnetic layer 3 of the media B, C, and D, the samples 4 to 6 in which only the soft magnetic layer 3 which consists of the above CoZrNb was formed on the substrate 1 were produced. The constitution of the substrate 1 used for the samples 4 to 6 and the soft magnetic layer 3 was the same as in that of the media B, C, and D, respectively.

The test pieces of the samples 4 to 6 were subjected to a magnetostatic characteristics evaluation, and as a result, it was confirmed that the magnetic anisotropy in the samples 4 to 6 was directed in a radial direction.

Each Bs of the samples 4 to 6 was 12000 G. Hc(s) of the radial direction of the samples 4 to 6 were 0.7 (Oe), 0.5 (Oe), and 0.1 (Oe), respectively.

Bs·Hc of the samples 4 to 6 were 8.4 kG·Oe, 6.0 kG·Oe, and 1.2 kG·Oe, respectively.

### Comparative Examples 4 and 5

In forming the soft magnetic layer 3 which consists of the above FeCoBC, the magnetic recording medium E was produced in the same way as in the Working Example 1, with the exception of not using the permanent magnet on the back of the target.

The magnetic recording medium F was produced in the same way as in the Working Example 1, with the exception of making the thickness of the soft magnetic layer 3 which consists of the above FeCoBC to be 120 nm.

The samples 7 and 8 in which only the soft magnetic layer 3 consisting of the above CoZrNb was formed on the substrate 1 were produced. The constitutions of the substrate 1 used for the samples 7 and 8, and the soft magnetic layer 3 were the same as that of Media E and F, respectively.

The sample 7 was magnetostatically isotropic and was not anisotropic. The coercive force Hc was 1.0 (Oe). As for the sample 8, the magnetic anisotropy was directed in a radial direction and the radial coercive force Hc of the sample 8 was 0.8 (Oe). Each Bs of the samples 7 and 8 was 16000 G.

Bs·Hc(s) of the samples 7 and 8 were 16.0 kG·Oe and 12.8 kG·Oe, respectively.

The magnetostatic characteristics were evaluated by the same way as in the Working Example 1 with respect to the magnetic recording media E and F. The results are shown in Table 1.

TABLE 1

| | Hc | Rs | −Hn | SNRm | OW | dPW50 | Bs · Hc |
|---|---|---|---|---|---|---|---|
| | (kOe) | (—) | (kOe) | (dB) | (dB) | (nm) | (kG · Oe) |
| Working Example1(medium A) | 4.3 | 1.00 | 2.1 | 22.1 | 44.2 | 68 | 11.2 |
| ComparativeExample1(mediumB) | 4.3 | 1.00 | 2.0 | 21.1 | 43.1 | 73 | 8.4 |
| ComparativeExample2(mediumC) | 4.2 | 0.99 | 2.0 | 20.8 | 43.0 | 73 | 6.0 |
| ComparativeExample3(mediumD) | 4.2 | 1.00 | 2.1 | 20.8 | 43.2 | 74 | 1.2 |
| ComparativeExample4(mediumE) | 4.3 | 1.00 | 2.1 | 20.8 | 43.9 | 71 | 16.0 |
| ComparativeExample5(mediumF) | 4.3 | 1.00 | 2.1 | 21.6 | 43.8 | 72 | 12.8 |

Table 1 shows that the medium A of Working Example 1 gives values which are superior to the medium of the Comparative Example as to the magnetic parametric performance (SNRm, OW, and dPW50).

Moreover, the medium F of Comparative Example 5 is excellent as to SNRm and OW compared with the medium of other Comparative Examples. It is thought that this is because the Bs·Hc is relatively large.

Moreover, although the medium E of Comparative Example 4 has a large Bs·Hc of the soft magnetic layer 3, the SNRm is low. It is thought that this is because the medium E does not have anisotropy.

As to dPW50, the medium A of Working Example 1 is superior to any of the Comparative Examples.

FIG. 4 shows the waveform for disk 1 round after DC erasing of the medium A of Working Example 1. Almost no signals were observed as shown in this figure.

FIG. 5 shows the waveform of the medium B of Comparative Example 1. The spike noise was observed as shown in this figure. As to the media C to F of Comparative Examples 2 to 5, the spike noise was observed similarly.

After magnetizing the soft magnetic layer 3 as to the media B and E of Comparative Examples 1 and 4 using magnetizing apparatus 31, when the waveform was observed without performing R/W measurement, almost no spike noise observed any longer, but spike noise was observed when R/W measurement was performed continuously.

On the other hand, as for the medium A of Working Example 1, no spike noise was observed even after R/W measurement.

From these results, it is thought that as for the medium A of Working Example 1, even when R/W measurement was performed, a magnetic region was not formed, but as for the medium of Comparative Example, a magnetic region is formed by R/W measurement, which causes generation of spike noise, thereby affecting the R/W measured value.

The result of Comparative Example 1 (medium B) shows that spike noise is generated, in the case in which the Bs·Hc is less than 79 T·A/m (10 kG·Oe), even if the magnetic anisotropy of the soft magnetic layer 3 is directed in the radial direction and the thickness of the soft magnetic layer 3 is less than 100 nM.

Moreover, the results of Comparative Examples 2 and 3 (media C and D) show that spike noise is generated, in the case in which the thickness of the soft magnetic layer 3 is not less than 100 nm and the Bs·Hc is less than 79 T A/m (10 kG·Oe).

In addition, the result of Comparative Example 4 (medium E) shows that spike noise is generated, in the case in which the magnetic anisotropy is low, even if the Bs·Hc is not less than 79 T·A/m (10 kG·Oe).

Furthermore, the result of Comparative Example 5 (medium F) shows that spike noise is also generated, in the case in which the thickness of the soft magnetic layer 3 is not less than 100 nm.

In every case, the spike noise deteriorates the R/W measured values.

As mentioned above, by using the soft magnetic layer having a thickness of less than 100 μm, the Bs·Hc value of not less than 79 T·A/m (10 kG·Oe), and magnetic anisotropy which is directed in a surface direction as a lining layer, formation of the magnetic wall in the soft magnetic layer 3 can be suppressed, and the magnetic recording medium which is excellent in the R/W characteristic can be obtained.

### Working Examples 2 and 3

The magnetic recording medium shown in FIG. 3 was produced as mentioned below.

The magnetic recording medium G was produced in the same way as in Working Example 1, with the exception of not forming the hard magnetic layer 2, using Fe: 24 at %, Co: 16 at %, B: 4 at %, and C for the soft magnetic layer 3, and setting the thickness of the soft magnetic layer 3 to be 50 nm.

When magnetostatic characteristics were evaluated in the same way as in Working Example 1, and it turned out that the soft magnetic layer 3 had a magnetic anisotropy in a radial direction, the Bs was 19000 G, the Hc was 10 (Oe), and the Bs·Hc was 190 kG·Oe (1500 T·A/m). The measurement result is shown in Table 2.

TABLE 2

| | Hc | Rs | −Hn | SNRm | OW | dPW50 | Bs · Hc |
|---|---|---|---|---|---|---|---|
| | (kOe) | (—) | (kOe) | (dB) | (dB) | (nm) | (kG · Oe) |
| Working Example2(mediumG) | 4.4 | 1.00 | 2.2 | 22.2 | 44.3 | 71 | 190 |
| Working Example1(mediumH) | 4.3 | 1.00 | 2.1 | 21.8 | 43.8 | 71 | 16 |

As for the medium G of Working Example 2, values which are almost equivalent to those of the medium A of Working Example 1 were obtained.

Moreover, similarly to Working Example 1, DC erasing was performed after R/W measurement, and as a result, no spike noise was observed.

As mentioned above, by using the soft magnetic layer having a thickness of less than 100 nm, the Bs·Hc value of not less than 79 T·A/m (10 kG·Oe), and magnetic anisotropy which is directed in a surface direction, formation of the magnetic wall in the soft magnetic layer 3 can be suppressed, and the magnetic recording medium which is excellent in the R/W characteristic can be provided, even when no hard magnetic layer is used.

### Working Example 3

The magnetic recording medium H was produced by the same way as in Working Example 1, with the exception of using Fe: 27 at %, Co: 10 at %, and B for the soft magnetic layer 3.

The medium H was disposed to a space between two electromagnets, and the hard magnetic layer 2 was magnetized, by generating the magnetic field of 10000 (Oe) from the electromagnet while rotating the electromagnet at 2000 rpm and moving the electromagnet in the direction of the perimeter linearly from the inner circumference, and thereafter stopping the rotation of the medium H.

The direction of the magnetostatic characteristics of the soft magnetic layer 3 and magnetic anisotropy and the direction of magnetization of the hard magnetic layer 2 were investigated similarly to Working Example 1.

The Bs of the soft magnetic layer 3 was 16000 G, the Hc was 1.0 (Oe), and the Bs·Hc was 16 kG·Oe. It turned out that although the magnetic anisotropy of the soft magnetic layer 3 was directed radially, the direction of magnetization of the hard magnetic layer 2 was a direction which shifted in the direction of the circumference 10 degrees to the radial direction. The measurement results are shown in Table 2.

As for the medium H of Working Example 3, although any measured value was slightly inferior to that of the medium A of Working Example 1, the R/W characteristic which is superior to that of the media B to F of Comparative Example was obtained.

Moreover, no spike noises were observed in the DC erasing which was performed after the R/W measurement.

As mentioned above, by using the soft magnetic layer having a thickness of less than 100 nm, the Bs·Hc of not less than 79 T·A/m (10 kG·Oe), and magnetic anisotropy which is directed to a surface direction as a lining layer, formation of the magnetic region in the soft magnetic layer 3 can be suppressed, and the magnetic recording medium which is excellent in R/W characteristics can be provided, even when the direction of magnetization of the hard magnetic layer 2 had shifted to the direction of the magnetic anisotropy of the soft magnetic layer 3.

### Working Example 4

The fourth embodiment of the present invention will be explained below, referring to the drawings.

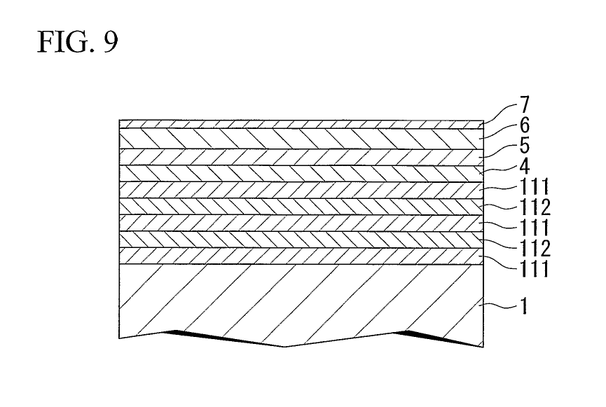

The magnetic recording medium shown in FIG. 9 was produced as follows. The magnetic recording medium I was produced in the same way as in Working Example 1, with the exception of laminating each of the three layers of the FeCoBC soft magnetic layer 111 and each of the two layers of the Ru layer 112 alternately, as shown in FIG. 9, by a sputtering method similar to the one used in preparing the substrate 1 in Working Example 1, instead of forming the hard magnetic layer 2 and the soft magnetic layer 3. Each FeCoBC soft magnetic layer 111 was formed by a sputtering method similar to the one used in preparing the substrate 1 in Working Example 1 so as to have a thickness of 25 nm, using a target which consists of Fe: 24 at %, Co: 16 at %, and B: 4 at %. Each Ru layer 112 was formed by a DC sputtering method to have a thickness of 5 nm, using an Ru target. In comparison with the recording medium G, the thickness of one layer of the soft magnetic layer in the magnetic recording medium I is thinner, but the three soft magnetic layers are laminated with an intervening layers made of non-magnetic substance therebetween. As a result, the total thickness of the soft magnetic layers is greater.

As the result of performing the same measurement as in Working Example 1 on the FeCoBC soft magnetic layer, it turned out that the FeCoBC soft magnetic layer in the magnetic recording medium I of the present invention has anisotropy in a radial direction, Bs of 18,000 G, He of 8 Oe, and Bs·Hc of 144 kG·Oe. The results measurement of the magnetic recording medium and the R/W characteristics similar to those in Working Example 1 are shown in Table 3.

TABLE 3

| | Hc | Rs | −Hn | SNRm | OW | dPW50 | Bs · Hc |
|---|---|---|---|---|---|---|---|
| | (kOe) | (—) | (kOe) | (dB) | (dB) | (nm) | (kG · Oe) |
| Working Example4(medium I) | 4.3 | 1.00 | 2.2 | 22.5 | 44.6 | 71 | 144 |

In the magnetic recording medium I of the present invention, characteristics of SNRm and of OW are superior to those of the medium A and of the medium G of the present invention, respectively. It can be thought that this is because while maintaining the Bs·Hc value to be not less than 10 kG·Oe, the soft magnetic layers are laminated so that the total thickness thereof is 75 nm, thereby stabilizing the magnetic anisotropy further. In addition, similar to in Working Example 1, a DC erasing was performed after R/W measurement to observe wave form, and no spike noise could be detected. It should be noted that as for the laminate constitution of the soft magnetic layer, the same effects could be obtained either in the case in which two layers were laminated, or in the case in which four layers were laminated, such that the total thickness of the soft magnetic layer is less than 100 nm.

As mentioned in the above, according to the present invention, by laminating the soft magnetic layer having a Bs·Hc value of not less than 10 kG·Oe and a magnetic anisotropy in the direction being parallel to the surface (radial direction), such that the total thickness of the soft magnetic layer is less than 100 nm, it becomes possible to prevent a magnetic domain from generating in the soft magnetic layer, to maintain the magnetic anisotropy stable further, and to provide a magnetic recording medium which excels in R/W characteristics.

1. A magnetic recording medium comprising a substrate, a perpendicular magnetic recording layer, and a soft magnetic layer formed therebetween, wherein the soft magnetic layer has a thickness of less than 100 nm, a magnetic anisotropy in a surface direction, and a Bs·Hc, which is a product of a saturation magnetic flux density Bs and a coercive force Hc, of not less than 79 T·A/m (10 kG·Oe).

2. A magnetic recording medium comprising a substrate, a perpendicular magnetic recording layer, and a plurality of soft magnetic layers formed therebetween, wherein the plurality of soft magnetic layers have a total thickness of less than 100 in, a magnetic anisotropy in a surface direction, and a Bs·Hc, which is a product of a saturation magnetic flux density Bs and a coercive force Hc, of not less than 79 T·A/m (10 kG·Oe).

3. A magnetic recording medium as set forth in claim 1, wherein the magnetic anisotropy of the soft magnetic layer is in a radial direction of the substrate.

4. A magnetic recording medium as set forth in claim 1, wherein a hard magnetic layer which suppresses a magnetic wall formation in the soft magnetic layer, is disposed between the substrate and the soft magnetic layer.

5. A magnetic recording medium as set forth in claim 4, wherein the hard magnetic layer is constituted so as to be magnetized in a direction substantially parallel to the direction of the magnetic anisotropy of the soft magnetic layer.

6. A process for producing a magnetic recording medium having a substrate, a perpendicular magnetic recording layer, and a soft magnetic layer formed therebetween, wherein the soft magnetic layer is formed, such that the thickness of the soft magnetic layer is less than 100 nm, the magnetic anisotropy thereof is in a surface direction, and a Bs·Hc is not less than 79 T·A/m (10 kG·Oe).

7. A magnetic reading-writing apparatus comprising the magnetic recording medium as set forth in claim 1, and a magnetic head for recording and reproducing information to the magnetic recording medium, wherein the magnetic head is a single magnetic pole head.
